(19) United States
(12) Patent Application Publication
(10) Pub. No.: US 2025/0376596 A1
(43) Pub. Date: Dec. 11, 2025

(54) Palette of 14 Sustainable Mineral Paints

(71) Applicant: M PRODUCOES LTDA, Serro/ Minas Gerais (BR)

(72) Inventor: Ana Elisa MURTA TOLENTINO, Serro/ Minas Gerais (BR)

(21) Appl. No.: 19/008,849

(22) Filed: Jan. 3, 2025

(30) Foreign Application Priority Data
Jun. 11, 2024 (BR) 10 2024 0141743 3

(51) Int. Cl. C09D 5/06; C08K 11/00; C09D 7/61; C09D 131/04

(52) U.S. Cl. CPC C09D 5/06; C09D 7/61; C09D 131/04; C08K 11/005

(57) ABSTRACT

The present disclosure applies to the production of ecological paints, which uses mineral pigments obtained from iron ore mining waste and tailings, transforming them into useful and sustainable products. The paints produced are free of volatile organic compounds (vocs), in line with international regulations and demands from conscious markets.

### CROSS-REFERENCE TO RELATED APPLICATION

This application claims priority to and takes the benefit of Brazilian patent application Ser. No. 1020240117433 filed on Jun. 11, 2024, the contents of which is hereby incorporated by reference into the present disclosure.

### TECHNICAL FIELD

Invention patent applies to the production of ecological paints, which uses mineral pigments obtained from iron ore mining waste and tailings, transforming them into useful and sustainable products. The paints produced are free of volatile organic compounds (VOCs), in line with international regulations and demands from conscious markets.

### BACKGROUND

The current market already has VOC-free paints, however, the innovation presented in this patent application lies in the complete use of mining waste, which is normally discarded as sterile or tailings, this approach not only reduces the environmental impact of mining, but also produces high quality and low cost paints.

### SUMMARY

The developed paint palette differs significantly from conventional products due to the use of pigments derived from mining waste. This exclusive 14-color palette is compatible with resins such as polyvinyl acetate (PvA), offering a sustainable alternative that maintains durability and strength comparable to commercial paints.

The manufacturing process for sustainable mineral paints is simple and easily applicable, offering significant benefits for all parties involved. Mining waste and waste, already in the form of grains or granules due to the extraction process itself, are collected. This aspect is particularly advantageous for the paint manufacturer, as it eliminates the need for pulverizing the rocks, a generally expensive step in the pigment production process.

Thus, the pigments arrive already sprayed, ready for use. Furthermore, this process is also beneficial for mining companies, which produce large amounts of waste and waste.

By providing these materials for the manufacture of paints, mining companies can give these by-products a useful purpose, contributing to more sustainable waste management. For the consumer, the resulting paint offers several advantages: it is an extremely durable product, with high coverage, low cost and non-toxic. Furthermore, it is environmentally friendly, as it does not contain volatile organic compounds (VOCs) that are harmful to the environment and human health. These materials, whether dry or not, are then mixed with a polyvinyl acetate (PvA) resin base.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

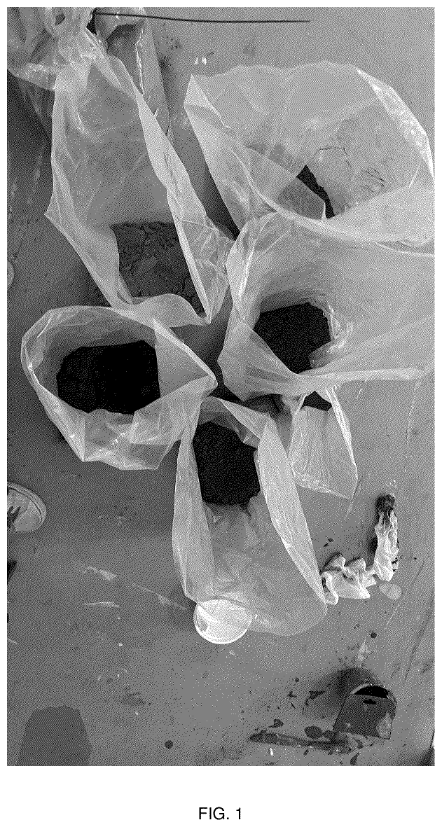

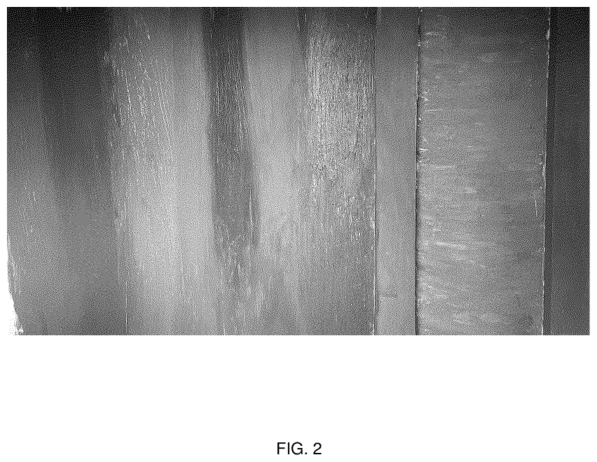

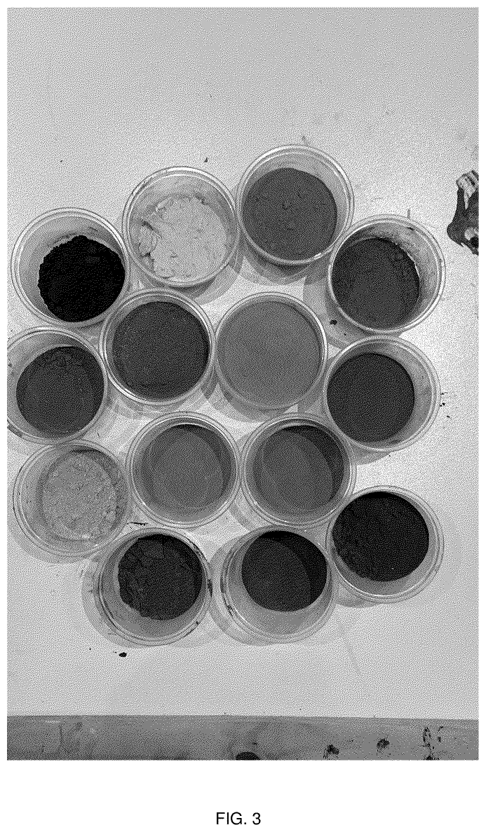

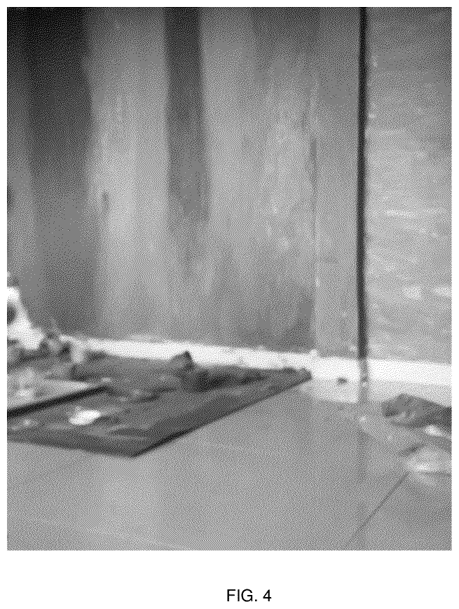

In FIGS. 1, 2, 3 and 4 we show the tones of the different colors created by the developed paint.

### DETAILED DESCRIPTION OF THE EMBODIMENTS

The ideal formulation consists of up to 50% pigment combined with 50% PvA resin. This proportion offers high coverage, allowing the paint to be applied directly to various surfaces, both internal and external, without the need for prior preparation. This eliminates the use of primers or other base treatments, simplifying the painting process and reducing costs. Increasing the percentage of the base, there is a reduction in the covering power and color intensity, without compromising the quality of the product as protection against bad weather, such as rain and erosion.

Furthermore, recent studies, such as the one carried out by Galvão et al. (2018), show that iron ore waste, when used as pigments, contributes significantly to the production of sustainable paints. The results indicate that PvA-based paints with waste pigments demonstrated excellent technical performance and durability, presenting low cost and properties comparable to commercial paints, in addition to a wide range of practical applications in civil construction, due to their stability and variety of colors and textures that can be achieved.

What is claimed is:

1. A palette comprising:
mineral pigments obtained from mining residues; and
tailings with a formulation made of up to 50% pigment combined with 50% PvA resin.

2. The palette according to claim 1 wherein the palette is free of volatile organic compounds.

3. The palette according to claim 1 wherein the palette is compatible with resins such as polyvinyl acetate and water-based mixtures of CAL and PvA.
